(19) United States
(12) Patent Application Publication
(10) Pub. No.: US 2019/0130775 A1
(43) Pub. Date: May 2, 2019

(54) INTERACTIVE DEVICE FOR OBJECT, PLAYPEN ENCLOSURE FOR CHILD, AND CRIB

(71) Applicant: BOE Technology Group Co., Ltd., Beijing (CN)

(72) Inventor: Liying Jia, Beijing (CN)

(21) Appl. No.: 15/916,308

(22) Filed: Mar. 9, 2018

(30) Foreign Application Priority Data
Oct. 30, 2017 (CN) 201711041194.X

(51) Int. Cl. G09B 5/06; A47D 13/06; A47D 7/00; A47D 15/00

(52) U.S. Cl. CPC G09B 5/065; A47D 13/06; A63H 2200/00; A47D 15/008; A47D 7/00

(57) ABSTRACT

An interactive device for an object, a playpen enclosure for child, and a crib are provided in the embodiments of the disclosure, which relate to the technical field of an electronic apparatus. A principle technical solution in embodiments of the disclosure lies in an interactive device for an object, including: an acquisition module, which is configured to track actions of the predetermined object and to extract status information of the actions in real-time; a processing module, which is arranged to be connected to the acquisition module, and configured to determine whether at least one threshold condition is met as a function of the status information, and to generate a control signal corresponding to the at least one threshold condition in the condition that the threshold condition is met; and an interactive module, which is arranged to be connected to the processing module, and configured to receive the control signal and to carry out a corresponding interactive operation depending on the control signal so as to interact with the object. Embodiments of the disclosure are mainly intended for communication and interaction with children.

### CROSS-REFERENCE TO RELATED INVENTION

The present disclosure claims the benefit of Chinese Patent Application Invention No. 201711041194.X filed on Oct. 30, 2017 in the State Intellectual Property Office of China, the whole disclosure of which is incorporated herein by reference.

### BACKGROUND OF THE INVENTION

### Field of the Invention

Embodiments of the present disclosure relate to the technical field of an electronic apparatus, and especially to an interactive device for an object, a playpen enclosure for child, and a crib.

### Description of the Related Art

Nowadays, guardians attach great importance to growth of children at their respective infant, baby, or kid stage; however, due to work or family life, in some families it may only be ensured that a child is typically taken care of by only one elder guardian. And when the child needs to be taken care of, in a short time period in which the guardian has to be absent, it is required that the child is left alone either in a crib or within a playpen enclosure so as to prevent the child from being exposed to any risk at the guardian's absence.

However, since the child at the infant, baby, or kid stage is highly dependent on the guardian, the absence of the guardian may typically lead to an emotional uneasiness and discomfort of the child, resulting in an excessive crying of the child.

### SUMMARY OF THE INVENTION

The embodiments of the present disclosure have been made to overcome or alleviate at least one aspect of the above mentioned disadvantages and/or shortcomings in the prior art, by providing an interactive device for an object, a playpen enclosure for child, and a crib.

Following technical solutions are adopted in exemplary embodiments of the invention for achieving the above desired technical purposes.

According to an aspect of the exemplary embodiment of the present disclosure, there is provided an interactive device for an object, comprising: an acquisition module, which is configured to track actions of the predetermined object and to extract status information of the actions in real-time; a processing module, which is arranged to be connected to the acquisition module, and configured to determine whether at least one threshold condition is met as a function of the status information, and to generate a control signal corresponding to the at least one threshold condition in the condition that the threshold condition is met; and an interactive module, which is arranged to be connected to the processing module, and configured to receive the control signal and to carry out a corresponding interactive operation depending on the control signal so as to interact with the object.

In an embodiment of the disclosure, the interactive module comprises a voice unit which is arranged to be connected to the processing module, and configured to receive the control signal and to play corresponding voice messages depending on the control signal

In an embodiment of the disclosure, the interactive module comprises a display unit which is arranged to be connected to the processing module, and configured to receive the control signal and to display corresponding images depending on the control signal.

In an embodiment of the disclosure, there are a plurality of threshold conditions functioning as the at least one threshold condition, which differ from one another and are set corresponding to different interactive operations to be carried out by the interactive module, comprising an operation to play different corresponding voice messages.

In an embodiment of the disclosure, there are a plurality of threshold conditions functioning as the at least one threshold condition, which differ from one another and are set corresponding to different interactive operations to be carried out by the interactive module, comprising an operation to display corresponding images.

In an embodiment of the disclosure, the acquisition module comprises a distance sensor which is configured to acquire distance information between the object and a target position, the distance information functioning as the status information; and the processing module is arranged to be connected to the distance sensor, and configured to determine whether a threshold distance which functions as one of the plurality of threshold conditions is met depending on the distance information, and to generate a control signal corresponding to the threshold distance in the condition that the threshold distance is met.

In an embodiment of the disclosure, the acquisition module comprises a pressure sensing portion and a pressure sensor provided on the pressure sensing portion and configured to detect pressure information on the pressure sensing portion, the pressure information functioning as the status information; and the processing module is arranged to be connected to the pressure sensor, and configured to determine whether a threshold pressure which functions as one of the plurality of threshold conditions is met depending on the pressure information, and to generate a control signal corresponding to the threshold pressure in the condition that the threshold pressure is met.

In an embodiment of the disclosure, the pressure sensing portion is of one of a circular ring structure, a plate-like structure and a hemispheric structure.

In an embodiment of the disclosure, the acquisition module comprises a camera which is configured to acquire image information of the object, the image information functioning as the status information; and the processing module is arranged to be connected to the camera, and configured to determine whether a designated action which functions as one of the plurality of threshold conditions is met depending on the image information, and to generate a control signal corresponding to the designated action in the condition that the designated action is met.

According to another aspect of the exemplary embodiment of the present disclosure, there is provided playpen enclosure for child, comprising: a plurality of playpen guard panels; and the interactive device as above, and the plurality of playpen guard panels abut against one another and extend peripherally in a full circle, and are assembled sequentially into an integral enclosure structure, and the interactive device is provided on one or more of the plurality of playpen guard panels.

According to yet another aspect of the exemplary embodiment of the present disclosure, there is provided a crib, comprising: a bed body; and the interactive device as above, and the bed body is provided with a fence, on which the interactive device is mounted.

In an embodiment of the disclosure, the bed body is further provided with a drive device, which is connected at a control terminal thereof to the interactive device, and the interactive device is further configured to control the drive device to drive the bed body in a swaying motion, and to play preset voice messages by a voice unit which is built in the interactive device.

### BRIEF DESCRIPTION OF THE DRAWINGS

The above and other features and advantages of the present disclosure will become more apparent and a more comprehensive understanding of the present disclosure can be obtained, by describing in detail exemplary embodiments thereof with reference to the accompanying drawings, in which:

FIG. 1 illustrates a block diagram of an interactive device provided in an exemplary embodiment of the disclosure; and

FIG. 2 illustrates a bock diagram of another interactive device provided in another exemplary embodiment of the disclosure;

FIG. 3(a)-3(c) illustrate pressure sensing portions of a circular ring structure, a plate-like structure and a hemispheric structure, respectively, according to embodiments of the disclosure;

FIG. 4 illustrates a structural schematic view of a playpen enclosure for child, according to an embodiment of the disclosure; and

FIG. 5 illustrates a structural schematic view of a crib, according to an embodiment of the disclosure.

### DETAILED DESCRIPTION OF EMBODIMENTS OF THE INVENTION

Exemplary embodiments of the present disclosure will be described hereinafter in detail with reference to the attached drawings, wherein the like reference numerals refer to the like elements. The present disclosure may, however, be embodied in many different forms, and thus the detailed description of the embodiment of the disclosure in view of attached drawings should not be construed as being limited to the embodiment set forth herein; rather, these embodiments are provided so that the present disclosure will be thorough and complete, and will fully convey the general concept of the disclosure to those skilled in the art.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

In order to further set forth specific technical means and associated effects thereof for achieving the desired technical purposes of the embodiments of the disclosure, by way of example and referring to embodiments hereinafter, an interactive device and specific embodiments of the disclosure concerning its structure, characteristics and effects will be illustrated in detail as below.

According to a general technical concept of embodiments of the present disclosure, as illustrated in FIG. 1, there is provided an interactive device for a predetermined object, comprising:

an acquisition module 1, which is configured to track actions of the predetermined object and to extract status information of the actions in real-time;

a processing module 2, which is arranged to be connected to the acquisition module 1, and configured to determine whether at least one preset threshold condition is met as a function of the status information, and to generate a control signal corresponding to the at least one preset condition in the condition that the preset condition is met; and

an interactive module 3, which is arranged to be connected to the processing module 2, and configured to receive the control signal and to carry out a corresponding interactive operation depending on the control signal so as to interact with the predetermined object

The acquisition module 1 is for example configured to track actions of the predetermined object and to extract status information of the actions in real-time, the predetermined object for example being a child or a pet, etc. And a variety of status information may be extracted from the actions of the predetermined object, such as, position information, posture/attitude information, and pressure information of the predetermined object, and the like, without any specific limitation being imposed in this connection in embodiment of the disclosure. And in order to acquire the variety of status information as above, there may be various corresponding acquisition modules 1 each of which function as an information acquisition apparatus respectively, such as (but not limited thereto): a pressure sensor, a distance sensor, a camera, and the like.

The processing module 2 is for example arranged to be connected to the acquisition module 1 which extracts status information of the predetermined object in real-time and deliver the status information to the processing module 2. And there may for example exist a logic judgment program which is pre-stored within the processing module 2 and constructed on a basis of one or more preset conditions, such that once a piece of above status information is identified and analyzed by the processing module 2, the processing module 2 makes a determination on whether the preset condition(s) in the processing module 2 may be met by running the logic judgment program, and then the interactive device may carry out different operations depending on a specific result of the determination: If yes (i.e., the preset condition(s) being met), then the processing module 2 may generate a corresponding control signal; if no (i.e., the preset condition(s) being not met), then the processing module 2 may not generate any control signal and continue to run the logic judgment program so as to pursue above determination on whether the preset condition(s) may be met depending on next piece of status information. Specifically, the processing module 2 is for example a processing device, such as, a processor, a programmable logic controller (PLC), etc.

The interactive module is for example configured to receive the control signal from the processing module 2 and to carry out a corresponding interactive operation depending on the control signal so as to interact with the object. For example, there may exist several interactive operations, such as, play sound (e.g., voice messages), display images (e.g., dynamic video or static images), manipulate a preset structure to carry out operational actions, without any specific limitation in this connection in embodiments of the disclosure. And in order to carry out aforementioned interactive operations correspondingly, there may also exist several interactive modules 3, such as, a speaker, a display, an electro-mechanical driver/actuator, and the like, without any specific limitation in this connection in embodiments of the disclosure.

Then, the interactive device according to embodiments of the disclosure is set forth in detail by depiction concerning its working processes and operating principle, hereinafter.

Above all, the acquisition module 1 is used to extract status information of the predetermined object in real-time.

Next, the processing module 2 is used to determine whether the preset condition(s) is/are met depending on the status information, and to generate a control signal corresponding to the preset condition(s) in the condition that the preset condition(s) is/are met.

Finally, the interactive module 3 is used to receive the control signal from the processing module 2 and to carry out a corresponding interactive operation based on the control signal so as to implement an interaction with the predetermined object.

The interactive device is provided in embodiments of the disclosure, intending to implement communication and interaction with the predetermined object. However, in the prior art, in the absence of the guardian temporarily, typically it may lead to an emotional uneasiness and discomfort of the child, resulting in an excessive crying of the child. In contrast, the interactive device provided in embodiments of the disclosure comprises the acquisition module, the processing module and the interactive module; and during a time period in which the guardian left the child which acts as the predetermined object, temporarily, once the child performs various actions such as movement, waving hand(s) and the like, the acquisition module above all acquires the status information of the child in real time, and the processing module in turn determines whether the status information meets the preset condition, and then generates a control signal corresponding to the met preset condition; next, once the interactive module receives the control signal, it carries out a corresponding interactive operation depending thereon, so as to implement communication and interaction between the child and the interactive device and to shift attention of the child, preventing occurrence of a crying phenomenon of the child.

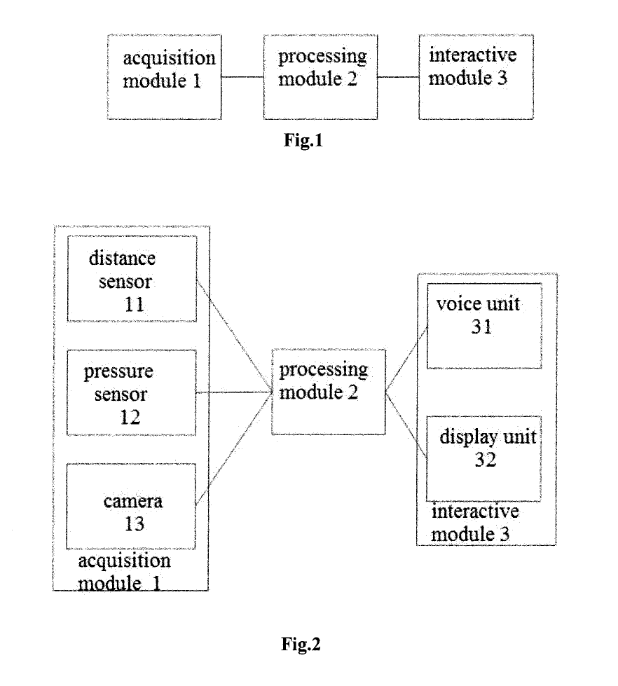

Furthermore, as illustrated in FIG. 2, the interactive module 3 may for example comprise a voice unit 31 which is arranged to be connected to the processing module 2, and configured to receive the control signal form the processing module 2 and to play corresponding voice messages depending on the control signal. As far as a generative mechanism of the voice messages are concerned, they may for example be sound/acoustic information which are pre-recorded and pre-stored within an internal memory of the voice unit 31, or generated by a built-in algorithm stored in the internal memory of the voice unit 30 as a function of the control signal. In an embodiment of the disclosure, the voice unit 31 may be a sounding device, e.g., a speaker. And once the voice unit 31 receives the control signal from the processing module 2, it may generate voice messages, specific contents of which may be music, human voice, sound of singing, or prompt tone, by way of example, without any specific limitation being applied in this connection herein. As a specific embodiment, in a practical application process, in the absence of the guardian, by way of example, the child may feel lonely and thus move or do some actions inadvertently; at that time the acquisition module 1 may extract the status information of the child in real time. Once the processing module 2 determines that the preset condition is met depending on the status information, the voice unit 31 may send corresponding voice messages so as to attract the child's attention; and once the child stops above movement or actions, the voice unit 31 stops sounding consequently; besides, the child may repeat the movement or actions thereof which had just be carried out in order to hear the voice messages once again, such that the voice unit 31 send the voice messages again. As such, in such repeated processes, the child may carry out a communication and interaction with the interactive device, so as to shift the attention and to avoid occurrence of crying phenomenon of the child, facilitating the child playing by himself/herself; therefore, an initiative of the child in autonomous entertainment is encouraged and a childcare responsibility/burden of the guardian is decreased consequently.

Apart from the voice unit 31, in an additional or alternative embodiment, aforementioned interactive module 3 may further be provided with other interactive unit(s). By way of example, as illustrated in FIG. 2, the interactive module 3 comprises a display unit 32 which is arranged to be connected to the processing module 2, and configured to receive the control signal therefrom and to display thereon corresponding image information (e.g., video or pattern) depending on the control signal. In an embodiment of the disclosure, the display device 32 is for example a display apparatus, such as, a display, a projector, and the like, without any specific limitation being applied in this connection in embodiments of the disclosure. And once the display unit 32 receives the control signal from the processing module 2, it may display corresponding images, specific contents of which may be action images of the child, images of parents, or demonstration of normative actions, etc., by way of example, without any specific limitation being applied in this connection herein. As a specific embodiment, in a practical application process, in the absence of the guardian, by way of example, the child may feel lonely and thus move or do some actions inadvertently; at that time the acquisition module 1 may extract the status information of the child in real time. Once the processing module 2 determines that the preset condition is met depending on the status information, the display unit 32 may display corresponding images so as to attract the child's attention; and once the child stops above movement or actions, the display unit 32 stops displaying aforementioned display information consequently; besides, the child may repeat the movement or actions thereof which had just be carried out in order to see the display information once again, such that the display unit 32 display images again. As such, in such repeated processes, the child may carry out a communication and interaction with the interactive device, so as to shift the attention and to avoid occurrence of crying phenomenon of the child, facilitating the child playing by himself/herself; therefore, an initiative of the child in autonomous entertainment is encouraged and a childcare responsibility/burden of the guardian is decreased consequently.

In order to further enrich contents of the interaction between the child and the interactive device, by way of example, there are a plurality of preset conditions, which differ from one another and are set corresponding to different interactive operations to be carried out by the interactive module 3, for example, comprising an operation to play same or different corresponding voice messages by the voice unit 31, and/or an operation to display same or different corresponding images by the display unit 32. In an embodiment of the disclosure, during an activity process of the child, the child may implement an interaction with the interactive device and a corresponding interactive operation may thus be implemented, by an inadvertent activity or action thereof. And since there are several preset conditions, then the child may hear same or different voice messages, and/or see same or different display information, depending on different activities or actions of the child; as such, the interactive device possesses relatively strong interactivity and interestingness in an effective interaction with the child.

In an embodiment of the disclosure, there may be various types of aforementioned acquisition module 1. As illustrated in FIG. 2, by way of example, the acquisition module 1 comprises a distance sensor 11 which is configured to acquire distance information between the predetermined object and a preset target position, the distance information functioning as the status information; and the processing module 2 is arranged to be connected to the distance sensor 11, and configured to determine whether a preset distance condition which functions as a preset condition is met depending on the distance information, and to generate a control signal corresponding to the preset distance condition in the case that the preset distance condition is met. In an embodiment of the disclosure, the distance sensor 11 may for example be an infrared sensor or a laser sensor. Specifically, when the child moves towards the preset target position, the acquisition module 1 may measure the distance between the child and the preset target position; and once the distance therebetween appears to be the preset distance, the interactive module 3 may play corresponding voice messages or display corresponding images, for example, play an audio file or a video file for early education, etc., so as to attract the child's attention, such that even in the absence of the guardian temporarily, the child may have a feeling of companionship, without occurrence of any agitation and uneasiness or crying phenomenon, facilitating the child playing by himself/herself; therefore, an initiative of the child in autonomous entertainment is encouraged and a childcare responsibility/burden of the guardian is decreased consequently.

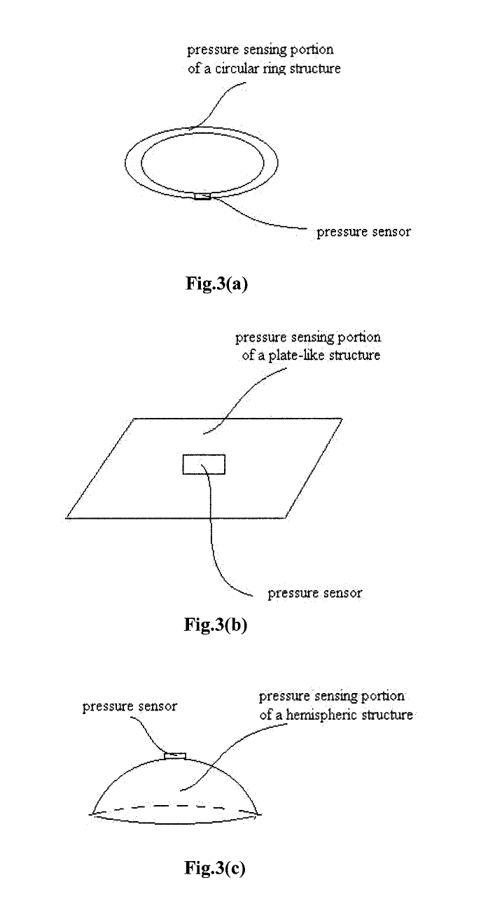

In an embodiment of the disclosure, there may still be various types of aforementioned acquisition module 1. As illustrated in FIG. 2 and FIGS. 3(a)-3(c), by way of example, the acquisition module 1 comprises a pressure sensing portion and a pressure sensor 12 provided on the pressure sensing portion and configured to detect pressure information on the pressure sensing portion, the pressure information functioning as the status information; and the processing module 2 is arranged to be connected to the pressure sensor 12, and configured to determine whether a preset pressure condition which functions as a preset condition is met depending on the pressure information, and to generate a control signal corresponding to the preset pressure condition in the case that the preset pressure condition is met. In an embodiment of the disclosure, once the child presses against, strikes on or pulls apart aforementioned pressure sensing portion, the pressure sensor 12 provided on the pressure sensing portion may measure the pressure information on pressing, striking or pulling in real time, and deliver the pressure information to the processing module 2; then the processing module 2 may determine whether the preset pressure condition is met depending on the pressure information and generate a corresponding control signal in the case that the preset pressure condition is met, so as to control the interactive unit to play sounds or display images, facilitating guiding the child to carry out the pressing, striking or pulling action again due to the effect of the played sounds or displayed images and thus implementing the communication and interaction between the child and the interactive device. Besides, by way of example, different forms of interactive operations like playing sounds or displaying images may be carried out depending on different magnitude of the pressure information, increasing the interestingness of the interaction therebetween.

Furthermore, the pressure sensing portion is for example of any one of a circular ring structure, a plate-like structure and a hemispheric structure. In embodiments of the disclosure, as illustrated in FIG. 3(a), the pressure sensing portion is for example of a circular ring shape and is provided to be suspended, such that the pressure sensor generates the pressure information once the child for example pulls on the pressure sensing portion accordingly; or alternatively, as illustrated in FIG. 3(b), the pressure sensing portion is for example of a plate-like shape and placed on the ground or on a playpen enclosure for child, such that the pressure sensor generates the pressure information once the child steps on or strikes at the pressure sensing portion; or otherwise alternatively, as illustrated in FIG. 3(c), the pressure sensing portion is for example of a hemispheric shape and provided on a playpen enclosure for child, and the pressure sensing portion is for example formed by an elastic material, such that the pressure sensor generates the pressure information once the child strikes at or presses against the pressure sensing portion. The pressure sensing portion in above forms of structures may facilitate extraction of status information from the child's actions by acquisition in real time, and subsequent interaction with the child by the processing module; besides, any injury to the child during activities thereof may be avoided accordingly by the acquisition in real time.

In an embodiment of the disclosure, there may still be various types of aforementioned acquisition module 1. As illustrated in FIG. 2, by way of example, the acquisition module 1 comprises a camera 13 which is configured to acquire image information of the predetermined object, the image information functioning as the status information; and the processing module 2 is arranged to be connected to the camera 13, and configured to determine whether a designated predetermined action condition which functions as a preset condition is met depending on the image information, and to generate a control signal corresponding to the predetermined action condition in the case that the predetermined action condition is met. In an embodiment of the disclosure, the camera 13 is used to take images of the child's actions by acquisition in real time, and the processing module 2 determining whether the predetermined action condition is met depending on the image information may for example refer to that it determines whether the image(s) of actions may be image(s) of the preset action by analysis of the image(s) of actions, e.g., the preset action may be actions of clapping, or actions of waving hand(s), or the like; and in the case that the preset action condition is met, then a corresponding interactive operation may be carried out by the interactive module 3, e.g., playing voice or displaying images so as to communicate and interact with the child. By way of example, when the child carries out the clapping actions, the interactive module 3 may for example play contents concerning etiquette and actions relating to clapping, further enhancing the interactivity between the child and the interactive device.

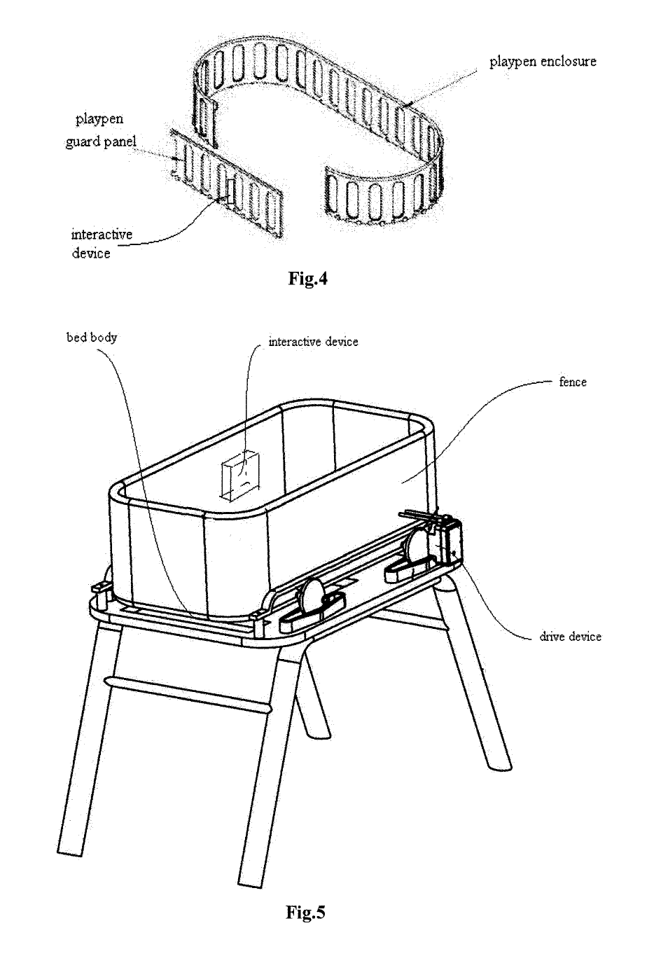

According to another aspect of the embodiments of the disclosure, as illustrated in FIG. 4, a playpen enclosure for child is further provided, which is used to bound an activity area therein for the child playing and to prevent any danger to the child, comprising:

a plurality of playpen guard panels; and

the interactive device,

and the plurality of playpen guard panels abut against one another and extend peripherally in a full circle, and are assembled sequentially into an integral enclosure structure, and the interactive device is provided on one or more of the plurality of playpen guard panels.

The playpen enclosure for child is provided in embodiments of the disclosure, for communication and interaction with the predetermined object. However, in the prior art, in the absence of the guardian temporarily, typically it may lead to an emotional uneasiness and discomfort of the child, resulting in an excessive crying of the child. In contrast, the playpen enclosure for child provided in embodiments of the disclosure comprises a plurality of playpen guard panels and the interactive device, the plurality of playpen guard panels abut against one another and extend peripherally in a full circle, and are assembled sequentially into an integral enclosure structure, and the interactive device is provided on one or more of the plurality of playpen guard panels and comprises an acquisition module, a processing module, and an interactive module. And during a time period in which the guardian left the child which acts as the predetermined object, temporarily, once the child performs various actions such as movement, waving hand(s) and the like, the acquisition module above all acquires the status information of the child in real time, and the processing module in turn determines whether the status information meets the preset condition, and then generates a control signal corresponding to the met preset condition; next, once the interactive module receives the control signal, it carries out a corresponding interactive operation depending thereon, so as to implement communication and interaction between the child and the interactive device and to shift attention of the child, preventing occurrence of a crying phenomenon of the child.

According to still another aspect of the embodiments of the disclosure, as illustrated in FIG. 5, a crib is further provided, comprising:

a bed body; and

the interactive device,

and the bed body is provided with a fence, on which the interactive device is mounted.

The crib is provided in embodiments of the disclosure, for communication and interaction with the predetermined object. However, in the prior art, in the absence of the guardian temporarily, typically it may lead to an emotional uneasiness and discomfort of the child, resulting in an excessive crying of the child. In contrast, the crib provided in embodiments of the disclosure comprises a bed body and the interactive device, and the bed body is provided with a fence, on which the interactive device is mounted; and the interactive device comprises an acquisition module, a processing module, and an interactive module. And during a time period in which the guardian left the child which acts as the predetermined object, temporarily, once the child performs various actions such as movement, waving hand(s) and the like, the acquisition module above all acquires the status information of the child in real time, and the processing module in turn determines whether the status information meets the preset condition, and then generates a control signal corresponding to the met preset condition; next, once the interactive module receives the control signal, it carries out a corresponding interactive operation depending thereon, so as to implement communication and interaction between the child and the interactive device and to shift attention of the child, preventing occurrence of a crying phenomenon of the child.

Moreover, as an alternative or in addition to the embodiments for carrying out aforementioned interactive operations (comprising play sounds and display images), by way of example, the bed body is further provided with a drive device, which is connected at a control terminal thereof to the interactive device, and the interactive device is further configured to control the drive device to drive the bed body in a swaying motion, and to play preset voice messages by a voice unit which is built in the interactive device. In the embodiment, e.g., in absence of the guardian temporarily, the child may be placed within the rib and may then carry out interaction and communication therebetween so as to be soothed, preventing occurrence of a crying phenomenon of the child. And in a case that the guardian is required to put the child to bed, similarly, the child is placed within the crib, and the interactive device controls the drive device on the bed body to drive the bed body in a swaying motion so as to help the child fall asleep; besides, the interactive device may play cradlesong by a voice unit which is built in the interactive device for sleep aid of the child, getting the child to sleep as quickly as possible and improving sleep quality.

It should be appreciated for those skilled in this art that the above embodiments are intended to be illustrated, and not restrictive. For example, many modifications may be made to the above embodiments by those skilled in this art, and various features described in different embodiments may be freely combined with each other without conflicting in configuration or principle.

Although the disclosure is described in view of the attached drawings, the embodiments disclosed in the drawings are only intended to illustrate the preferable embodiment of the present disclosure exemplarily, and should not be deemed as a restriction thereof.

Although several exemplary embodiments of the general concept of the present disclosure have been shown and described, it would be appreciated by those skilled in the art that various changes or modifications may be made in these embodiments without departing from the principles and spirit of the disclosure and lie within the scope of present application, which scope is defined in the claims and their equivalents.

As used herein, an element recited in the singular and proceeded with the word “a” or “an” should be understood as not excluding plural of said elements or steps, unless such exclusion is explicitly stated. Furthermore, references to “one embodiment” of the present disclosure are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

What is claimed is:

1. An interactive device for an object, comprising:
an acquisition module, which is configured to track actions of the predetermined object and to extract status information of the actions in real-time;
a processing module, which is arranged to be connected to the acquisition module, and configured to determine whether at least one threshold condition is met as a function of the status information, and to generate a control signal corresponding to the at least one threshold condition in the condition that the threshold condition is met; and
an interactive module, which is arranged to be connected to the processing module, and configured to receive the control signal and to carry out a corresponding interactive operation depending on the control signal so as to interact with the object.

2. The interactive device according to claim 1, wherein the interactive module comprises a voice unit which is arranged to be connected to the processing module, and configured to receive the control signal and to play corresponding voice messages depending on the control signal.

3. The interactive device according to claim 1, wherein the interactive module comprises a display unit which is arranged to be connected to the processing module, and configured to receive the control signal and to display corresponding images depending on the control signal.

4. The interactive device according to claim 2, wherein there are a plurality of threshold conditions functioning as the at least one threshold condition, which differ from one another and are set corresponding to different interactive operations to be carried out by the

8. The interactive device according to claim 1, wherein
the acquisition module comprises a camera which is configured to acquire image information of the object, the image information functioning as the status information; and
the processing module is arranged to be connected to the camera, and configured to determine whether a designated action which functions as one of the plurality of threshold conditions is met depending on the image information, and to generate a control signal corresponding to the designated action in the condition that the designated action is met.

9. A playpen enclosure for child, comprising:
a plurality of playpen guard panels; and
the interactive device according to claim 1,
wherein the plurality of playpen guard panels abut against one another and extend peripherally in a full circle, and are assembled sequentially into an integral enclosure structure, and
wherein the interactive device is provided on one or more of the plurality of playpen guard panels.

10. A crib, comprising:
a bed body; and
the interactive device according to claim 1,
wherein the bed body is provided with a fence, on which the interactive device is mounted.

11. The crib according to claim 10, wherein
the bed body is further provided with a drive device, which is connected at a control interactive module, comprising an operation to play different corresponding voice messages.

5. The interactive device according to claim 4, wherein
the acquisition module comprises a distance sensor which is configured to acquire distance information between the object and a target position, the distance information functioning as the status information; and
the processing module is arranged to be connected to the distance sensor, and configured to determine whether a threshold distance which functions as one of the plurality of threshold conditions is met depending on the distance information, and to generate a control signal corresponding to the threshold distance in the condition that the threshold distance is met.

6. The interactive device according to claim 4, wherein
the acquisition module comprises a pressure sensing portion and a pressure sensor provided on the pressure sensing portion and configured to detect pressure information on the pressure sensing portion, the pressure information functioning as the status information; and
the processing module is arranged to be connected to the pressure sensor, and configured to determine whether a threshold pressure which functions as one of the plurality of threshold conditions is met depending on the pressure information, and to generate a control signal corresponding to the threshold pressure in the condition that the threshold pressure is met.

7. The interactive device according to claim 6, wherein
the pressure sensing portion is of one of a circular ring structure, a plate-like structure and a hemispheric structure.
terminal thereof to the interactive device, and
wherein the interactive device is further configured to control the drive device to drive the bed body in a swaying motion, and to play preset voice messages by a voice unit which is built in the interactive device.

12. The interactive device according to claim 3, wherein there are a plurality of threshold conditions functioning as the at least one threshold condition, which differ from one another and are set corresponding to different interactive operations to be carried out by the interactive module, comprising an operation to display corresponding images.

13. The interactive device according to claim 12, wherein
the acquisition module comprises a distance sensor which is configured to acquire distance information between the object and a target position, the distance information functioning as the status information; and
the processing module is arranged to be connected to the distance sensor, and configured to determine whether a threshold distance which functions as one of the plurality of threshold conditions is met depending on the distance information, and to generate a control signal corresponding to the threshold distance in the condition that the threshold distance is met.

14. The interactive device according to claim 12, wherein
the acquisition module comprises a pressure sensing portion and a pressure sensor provided on the pressure sensing portion and configured to detect pressure information on the pressure sensing portion, the pressure information functioning as the status information; and
the processing module is arranged to be connected to the pressure sensor, and configured to determine whether a threshold pressure which functions as one of the plurality of threshold conditions is met depending on the pressure information, and to generate a control signal corresponding to the threshold pressure in the condition that the threshold pressure is met.

15. The interactive device according to claim 14, wherein
the pressure sensing portion is of one of a circular ring structure, a plate-like structure and a hemispheric structure.
